(19) United States
(12) Patent Application Publication
(10) Pub. No.: US 2007/0196211 A1
(43) Pub. Date: Aug. 23, 2007

(54) PUMP WITH IMPELLER, PARTICULARLY FOR WASHING MACHINES AND SIMILAR HOUSEHOLD APPLIANCES

(75) Inventor: Elio Marioni, Dueville (Vicenza) (IT)

Correspondence Address: AKERMAN SENTERFITT, P.O. BOX 3188, WEST PALM BEACH, FL, 33402-3188, US

(73) Assignee: Askoll Holding S.r.l., Povolaro di Dueville (Vicenza) (IT)

(21) Appl. No.: 11/466,976

(22) Filed: Aug. 24, 2006

(30) Foreign Application Priority Data
Aug. 30, 2005 (EP) 05425605.2

(51) Int. Cl. B64C 11/00

(52) U.S. Cl. 416/175

(57) ABSTRACT

A pump with impeller, particularly for washing machines and similar household appliances, comprising:
a synchronous electric motor with permanent magnets rotor (5), contained in a pump body (2), and with a driving shaft (7) that axially crosses the rotor (5);
an impeller (25) kinematically connected to said shaft (7) comprising a hub (26) with a plurality of vanes (30) projecting from a prevailing portion (28) thereof;
said impeller (25) comprising at least one auxiliary vane (35) projecting from the residual portion (29) of the hub (26) suitable for generating a fluid-dynamic motion to move away the possible lints present in the washing fluid.

### FIELD OF APPLICATION

The present invention refers to a pump with impeller, particularly for washing machines and similar household appliances.

More specifically, the invention concerns a pump with impeller, particularly for washing machines and similar household appliances, comprising:
a synchronous electric motor with permanent-magnets rotor, contained in a pump body, and with a driving shaft that axially crosses the rotor;
an impeller kinematically connected to the shaft comprising a hub with a plurality of vanes projecting from a prevailing portion of the hub.

### PRIOR ART

As is well known, pumps installed in washing machines for domestic and industrial use allow, during particular washing steps, to suck, from an inlet of the pump, a washing liquid to make it flow towards an outlet.

The pumped washing liquid passes through a chamber of the impeller, where an impeller kinematically connected to a motor of the pump through a driving shaft allows a fluid-dynamic motion to be created suitable for supplying liquid allowing the flow thereof.

In known pumps, the impeller comprises a hub with a plurality of vanes projecting from a prevailing portion thereof called vane-like portion and a residual substantially annular crown-shaped portion with a diameter that, according to the solutions adopted, can be substantially lower than or equal to the diameter of the vane-like portion.

The residual portion of the hub helps the flow of possible solid material present in suspension in the lye avoiding it blocking the vane-like passages of the impeller by getting caught between the vanes.

This makes the washing water supply better and more efficient.

Such known types of pumps, with such, although satisfactory, impellers, nevertheless have drawbacks deriving particularly from the fact that in the washing water there are residues that tend to become tangled in correspondence with the impeller. Such residues generally comprise lints, i.e. filaments obtained by unthreading the washed fabrics, which, during the washing steps, can constitute more or less densetufts.

In particular, such lints during the washing steps roll up in correspondence with the residual portion of the hub, penetrating, in some cases, under the impeller itself.

In fact, such residual portion of the hub acts as a “capstan” for the lints contained in the washing water that easily manage to wind on the residual portion of the hub tightly and insistently, during the operation of the impeller, to the point of blocking it, thus damaging the impeller or the motor of the pump and in any case interrupting the supply.

To block the penetration of the lints under the impeller it is known to make labyrinth-like connection systems in correspondence with the residual portion of the hub. Nevertheless, such labyrinth-like systems prove to be little effective in the presence of a substantial number of lints.

The technical problem underlying the present invention is that of devising and providing a pump with impeller having such structural and functional characteristics as to overcome the drawbacks cited with reference to the prior art.

### SUMMARY OF THE INVENTION

The invention has been achieved on the basis of the intuition that the lints tend to infinitesimally approach and wind around the hub with substantial intractability.

The solution idea underlying the present invention is that of countering the winding of the lints with a fluid-dynamic action.

On the basis of such solution idea, the technical problem is solved by a pump with impeller, particularly for washing machines and similar household appliances, of the type specified characterised in that at least one auxiliary vane projects from the residual portion of said hub.

Further characteristics and advantages of the pump with impeller according to the invention will become apparent from the following description of a preferred embodiment thereof, given by way of indicative and not limiting example with reference to the attached drawings.

### BRIEF DESCRIPTION OF THE DRAWINGS

In the drawings:

FIG. 1 schematically represents a perspective and partially exploded view of a portion of a pump made according to the present invention;

FIG. 2 schematically represents a section view of the pump portion of FIG. 1 assembled;

FIG. 3 represents a perspective view of an impeller made according to the present invention;

FIG. 4 represents a perspective view of a pump made according to the present invention.

### DETAILED DESCRIPTION

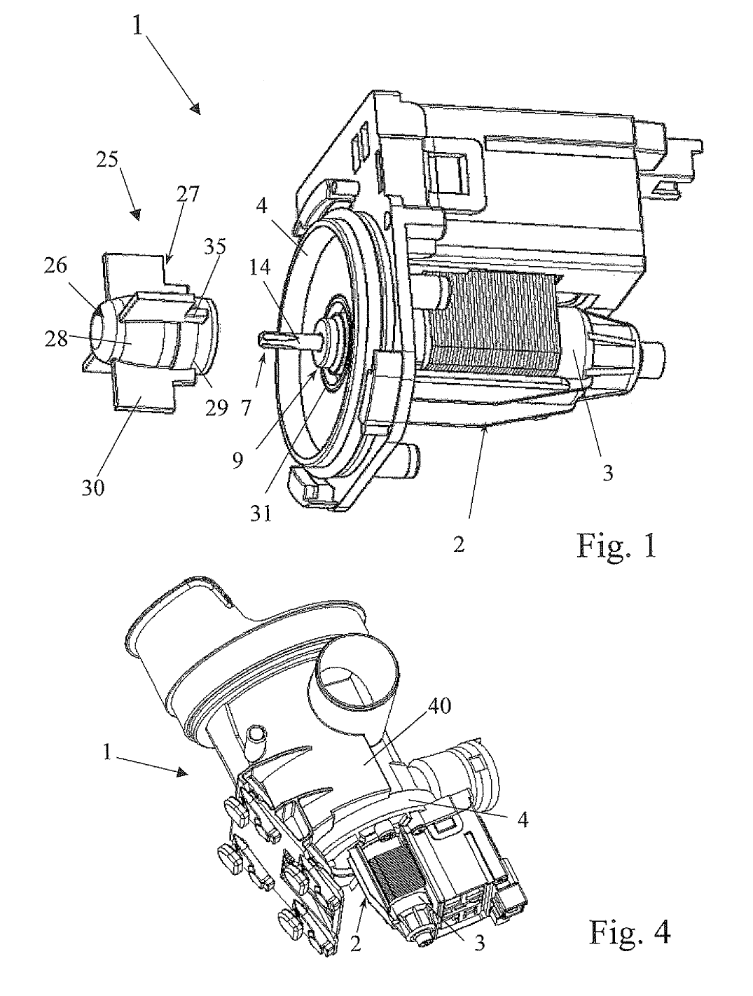

With reference to the attached figures, and in particular to FIG. 1, a portion of a pump that comprises an electric motor, which in the illustrated example is of the synchronous type with an inner rotor and an outer stator, is identified with 1.

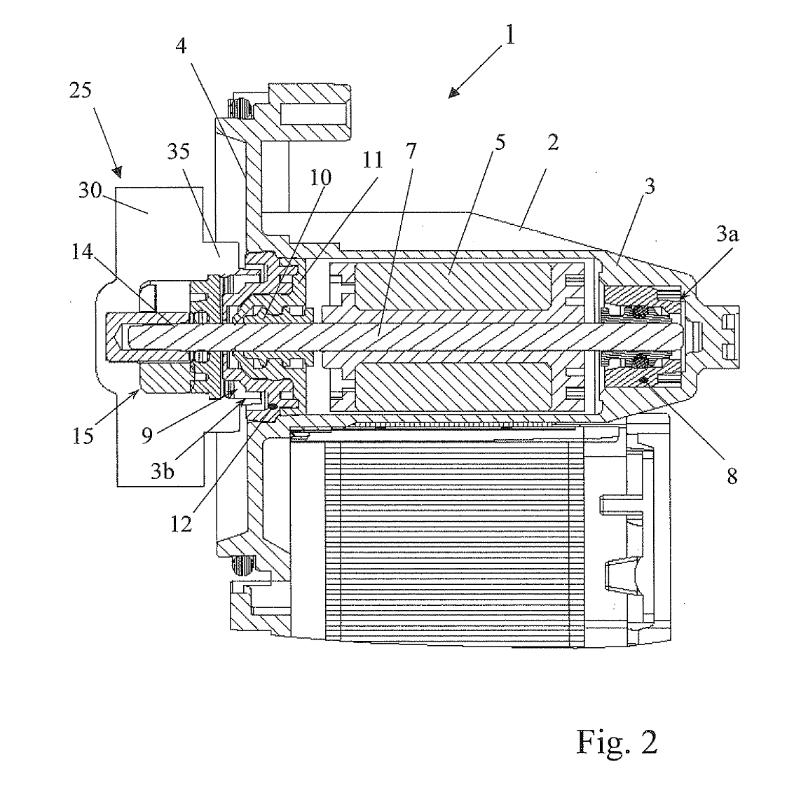

The pump 1 has, as illustrated in FIG. 2, a pump body 2 that comprises a substantially cylindrical casing 3 for a permanent-magnets rotor 5 contained inside closed by opposite bottoms: first lower bottom 3a and second upper bottom 3b. The pump body 2, as highlighted in FIG. 4, comprises a flange 4, which, as in the illustrated example, can be made integrally with the casing 3, suitable for allowing the connection with an upper cover 40, comprising an inlet and a delivery for the passage of the washing water.

As illustrated in FIG. 2, the rotor 5, enclosed in the casing 3, is crossed by a driving shaft 7 that is supported and centred by a first bushing 8, housed in the first bottom 3a, of the known type, and by a second bushing 9 housed in the second bottom 3b close to the flange 4.

The bushing 9, in the present embodiment, is of the sliding type and it is made through a bushing 10 mounted on a gasket 11, which is snap associated with a gasket-holder 12.

The bushing 9 allows the passage of the shaft 7 and defines a second centring and support point for the rotation of the shaft 7 itself.

The bushing 9 and in particular the gasket-holder 12 is housed perfectly fitting in a predefined recess 13 made inside the casing 3, whereas the gasket 11 has an outer diameter substantially equal to the internal diameter of the casing 3. In such way, the second bushing 9 defines a hermetical sealing lid for the casing 3 itself.

The driving shaft 7 projects with one end 14 from the second bushing 9 and is kinematically connected to an impeller 25.

The impeller 25 comprises a hub 26 with a plurality of vanes 30 projecting from a prevailing portion 28 thereof. The impeller 25, moved by the driving shaft 7, defines a fluid-dynamic action on the washing fluid of the washing machine.

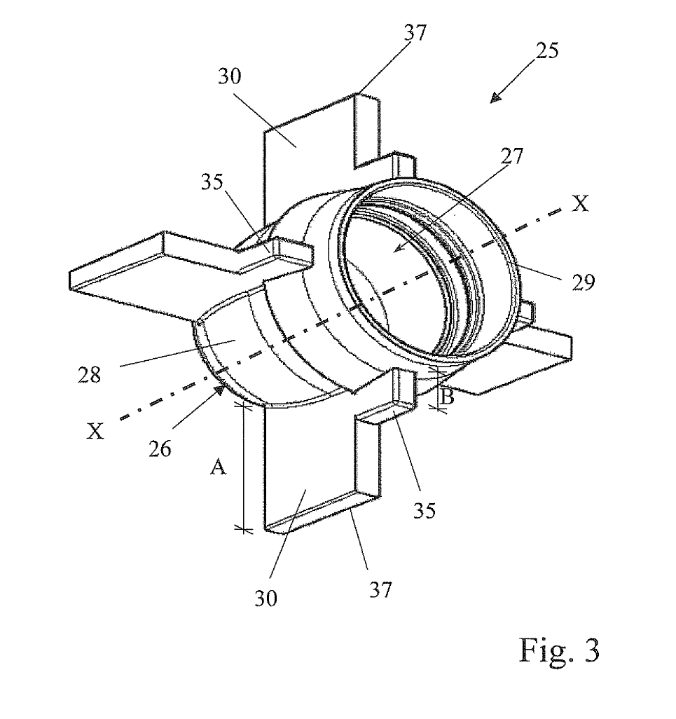

In the particular illustrated embodiment, the impeller 25, as highlighted in FIG. 3, comprises four vanes 30 that are preferably arranged in correspondence with the comers of a square.

The vanes 30, according to a preferred embodiment, have a substantially rectangular perimetric edge.

Advantageously, the impeller 25, according to the present invention, comprises at least one auxiliary vane 35 projecting from the residual portion 29 of the hub 26.

Advantageously, the auxiliary vanes 35 are two or more in number projecting from the residual portion 29 of the hub 26 symmetrically with respect to a longitudinal axis X-X. This is to keep a constructive symmetry of the impeller 25 with respect to the longitudinal axis X-X or rotation axis making its operation easier and to increase the strength and lifetime of the impeller itself.

In the illustrated embodiment, the auxiliary vanes 35 are as many as the vanes 30, thus four, and also have a substantially rectangular perimetric edge.

Preferably, the auxiliary vanes 35 and the vanes 30 are coplanar and made integrally in one piece.

Advantageously, moreover, the vanes 30 and the auxiliary vanes 35 define a substantially step-like profile 37.

Suitably, moreover, the size of the auxiliary vanes 35 is such as to create a fluid-dynamic effect but at the same time a power absorption of predetermined limited value, sufficient to take possible lints present in the washing fluid away from the residual portion 29 of the hub 26.

In other words, the fluid-dynamic effect of the auxiliary vanes 35 is sufficient to keep the lints away from the hub 26 without effecting the capacity of the motor of the pump 1.

Preferably, the vanes 30 have a radial width A substantially shorter than a second radial width B of the auxiliary vanes 35.

In a different embodiment, the auxiliary vanes 35 could be detached from the vanes 30 or else made between one vane 30 and the other.

In the pumps 1 supplied by a synchronous motor, the start up can indifferently occur in both directions of rotation and therefore, to avoid a load increase during the start up of the motor, it is worthwhile delaying the start up of the impeller 25 comprising suitable transmission means 15 between the driving shaft 7 and the impeller 25.

In the present embodiment, the impeller 25 is kinematically connected to the end 14 of the driving shaft 7 through the transmission means 15 that are made according to the teachings described in European patent no. 0287984B1 to the same Applicant.

In particular, therefore, the impeller 25 has an inner recess 27 engaged by the transmission means 15 connected to the shaft 7 and closed by a tight washer 36 suitable, possibly, for containing a viscous fluid in the inner recess 27 to dampen and/or absorb the possible knocks and noises generated by the transmission means 15.

Preferably, in the present embodiment, a lower end of the residual portion 29 is housed in a matching seat 31, made in the second bushing 9 and in particular in the gasket-holder 12.

Furthermore, the present invention also refers to an impeller 25 for a pump 1 for washing machines and similar household appliances.

In the following description reference is made to an impeller and to a pump and the same reference numbes previously indicated shall be kept to identify details having the same structure and function.

The impeller 25, illustrated in FIG. 1, is of the type kinematically connected to a driving shaft 7 of the pump 1.

The impeller 25 comprises a hub 26 with a plurality of vanes 30 projecting from a prevailing portion 28 thereof. The impeller 25, moved by the driving shaft 7 defines a fluid-dynamic action on the washing fluid of the washing machine.

In the particular illustrated embodiment, the impeller 25, as highlighted in FIG. 3, comprises four vanes 30 that are preferably arranged in correspondence with the comers of a square.

The vanes 30, according to a preferred embodiment, have a substantially rectangular perimetric edge.

Advantageously, according to the present invention, the impeller 25 has at least one auxiliary vane 35 projecting from the residual portion 29 of the hub 26.

Suitably, the auxiliary vanes 35 are two or more in number projecting from the residual portion 29 of the hub 26, symmetrically with respect to a longitudinal axis X-X. This is to keep a constructive symmetry of the impeller 25 with respect to the longitudinal axis X-X or rotation axis to make it easier for it to work and to increase its lifetime.

In the illustrated embodiment, the auxiliary vanes 35 are as many as the vanes 30, thus four, and also have a substantially rectangular perimetric edge and preferably they are coplanar and made integrally in one piece with the vanes 30.

Suitably, moreover, the size of the auxiliary vanes 35 is such as to create a fluid-dynamic effect but at the same time a power absorption of predetermined limited value, sufficient to take possible lints present in the washing fluid away from the residual portion 29 of the hub 26.

In other words, the capacity of the auxiliary vanes 35 is sufficient to keep the lints away from the hub 26 without burdening the capacity of the motor of the pump 1.

Preferably, the vanes 30 have a substantially smaller radial width A than a second radial width B of the auxiliary vanes 35.

In a different embodiment, the auxiliary vanes 35 could be detached from the vanes 30 or else made between one vane 30 and the other.

The main advantage of the pump with impeller according to the present invention is that the auxiliary vanes, projecting from the residual portion of the impeller, allow a fluid-dynamic action to be generated countering and moving away the lints or other residues present in the washing water pumped by the impeller, avoiding possible interruptions in the supply without burdening the capacity of the motor of the pump.

Another substantial advantage of the present invention is that of making an impeller with irregular perimeter with at least one auxiliary vane projecting from the residual portion of the hub to avoid the occurrence of possible “capstans” for the possible lints that, subject to the fluid-dynamic action generated by said at least one auxiliary vane, are subject to the fluid-dynamic action of the vanes of the impeller and thus made to flow away.

A further substantial advantage of the present invention is linked to the fact that, since the pump is actuated by a synchronous electric motor, the impeller made according to the present invention, moving the lints away, allows possible changes of the motor load to be avoided therefore keeping an optimal balance in size between power supplied by the motor and connected load, allowing a longer lifetime of the pump.

Another advantage of the pump with impeller with improved structure for washing machines and similar household appliances, made according to the present invention, is that of substantially improving the conditions during air-water operation of the pump, in fact, in such case, the impeller free from filaments or residues avoids overloads of the motor during the repeated start ups of the motor in such conditions.

Another advantage of the pump made according to the present invention with an impeller with vanes and auxiliary vanes made integrally in one piece is that of obtaining an optimal balancing of the impeller allowing the possible wearing thereof to be reduced.

A further substantial advantage of the impeller made according to the present invention is that it can be made at a low cost on a large and very large scale, an important advantage for an item intended to be employed in widely used products.

1. Pump with impeller, particularly for washing machines and similar household appliances, comprising:
a synchronous electric motor with permanent magnets rotor (5), contained in a pump body (2), and with a driving shaft (7) that axially crosses said rotor (5);
an impeller (25) kinematically connected to said shaft (7) comprising a hub (26) with a plurality of vanes (30) projecting from a prevailing portion (28) thereof,
characterised in that at least one auxiliary vane (35) projects from the residual portion (29) of said hub (26).

2. Pump according to claim 1, characterised in that the auxiliary vanes (35) are two or more in number projecting from the residual portion (29) of said hub (26) symmetrically with respect to a longitudinal axis X-X.

3. Pump according to claim 1, characterised in that said auxiliary vanes (35) are as many as said vanes (30).

4. Pump according to claim 3, characterised in that said auxiliary vanes (35) are coplanar to said vanes (30) defining a substantially step-like profile (37) of said vanes (30) and of said auxiliary vanes (35).

5. Pump according to claim 3, characterised in that said auxiliary vanes (35) and said vanes (30) are made integrally in one piece.

6. Impeller for a pump for washing machines and similar household appliances, of the type kinematically connected to a driving shaft (7) of said pump (1) and having a hub (25) with a plurality of vanes (30) projecting from a prevailing portion (28) thereof, characterised in that at least one auxiliary vane (35) projects from the residual portion (29) of said hub (26).

7. Impeller according to claim 6, characterised in that said auxiliary vanes (35) are two or more in number projecting from the residual portion (29) of said hub (26) symmetrically with respect to a longitudinal axis X-X.

8. Impeller according to claim 7, characterised in that said auxiliary vanes (35) are equal in number to said vanes (30).

9. Impeller according to claim 8, characterised in that said auxiliary vanes (35) are coplanar to said vanes (30) defining a substantially step-like profile (37) of said vanes (30) and of said auxiliary vanes (35).

10. Impeller according to claim 9, characterised in that said auxiliary vanes (35) and said vanes (30) are made integrally in one piece.
